(19) United States
(12) Patent Application Publication
(10) Pub. No.: US 2015/0082340 A1
(43) Pub. Date: Mar. 19, 2015

(54) DISPLAY SYSTEM, DISPLAY DEVICE, TRANSMISSION DEVICE, METHOD OF CONTROLLING DISPLAY DEVICE, AND METHOD OF CONTROLLING TRANSMISSION DEVICE

(71) Applicant: SHARP KABUSHIKI KAISHA, Osaka-shi, Osaka (JP)

(72) Inventor: Kazuma Naito, Osaka-shi (JP)

(73) Assignee: SHARP KABUSHIKI KAISHA, Osaka-shi, Osaka (JP)

(21) Appl. No.: 14/391,317

(22) PCT Filed: Mar. 15, 2013
(86) PCT No.: PCT/JP2013/057513

§ 371 Date: Oct. 8, 2014

(30) Foreign Application Priority Data
Apr. 25, 2012 (JP) 2012-100463

(51) Int. Cl. H04N 21/443; H04N 5/445; H04N 21/85; H04N 21/431; H04N 21/485

(52) U.S. Cl. CPC H04N 21/4438; H04N 21/4316; H04N 21/485; H04N 21/85; H04N 5/44591
USPC 725/32

(57) ABSTRACT

The present invention is capable of appropriately display, on a display, OSDs such as respective menus of the display and a connected apparatuses that is connected to the display and that is capable of working with the display. A display device (30) obtains a type of a transmitter-side OSD image superimposed by the transmission device (10) on a transmitter-side OSD superimposed video signal, and decides whether or not to superimpose a display-side OSD image on a display-side OSD superimposed video signal that is to be displayed, in accordance with the type of the transmitter-side OSD image and a type of the display-side OSD image.

### TECHNICAL FIELD

The present invention relates to a transmission device for transmitting a video signal and a display device for receiving thus transmitted video signal and carrying out display. Particularly, the present invention relates to a display device, a transmission device, a display system, a method of controlling the display device, a method of controlling the transmission device, a control program, and a control program and a storage medium, each of which is for display control of an OSD that works with the display device and the transmission device.

### BACKGROUND ART

In recent years, the number of digital apparatuses capable of transmitting a video signal to a connected display has been increasing. Because such digital apparatuses have increased, a display and such a digital apparatus are arranged to work with each other. As a result, operability has been improved. Further, currently, a connection method is being shifted from a wired connection to a wireless connection.

Patent Literature 1 discloses a video image processing apparatus as a controller apparatus for appropriately controlling a display state of an OSD synthesized by each of the controller apparatus and a target apparatus, and a video image processing apparatus as the target apparatus. More specifically, an OSD state checking section of the controller apparatus transmits a check instruction to an OSD control section of the target apparatus via a 1394 bus, so as to cause the OSD control section of the target apparatus to check a display state of an OSD synthesizing section and notify of a result of checking the display via the 1394 bus. Then, an operation selecting section of the controller apparatus selects whether to send an input from an input section to an OSD control section of the target apparatus or an OSD control section of the controller apparatus, based on the result of checking the OSD state. In this way, the OSD display state of the target apparatus is checked by the controller apparatus, and then, in accordance with a check result, an OSD display of the controller apparatus or an operation target of operation via a remote controller can be decided. This makes it possible to carry out appropriate display and operation.

### CITATION LIST

### Patent Literature

Patent Literature 1

Japanese Patent Application Publication, Tokukai, No. 2002-108326 (Publication Date: Apr. 10, 2002)

### SUMMARY OF INVENTION

### Technical Problem

However, in the above-described conventional configuration, every time an operation is made on a menu that is provided, for setting various functions, on each of a display and an externally connected digital apparatus, it is required to check a state of a counterpart apparatus and decide an exclusive display control of the menu and an operation target. This may impair operability.

Further, assume a case where in a system where the display and the externally connected digital apparatus are wirelessly connected, disconnection between the display and the externally connected digital apparatus occurs due to deterioration in connection, while a menu that works with the externally connected digital apparatus is opened. Then, as a result of the disconnection, a setting may be set via the menu by erroneous information. In this case a discrepancy may occur between a state of the display and a state the externally connected digital apparatus. Further, there may be a case where a user cannot set a setting by use of a menu due to disconnection caused by deterioration in connection between the display and the externally connected digital apparatus. In such a case, the menu is kept displayed in despite of a state where a user cannot set the setting by use of the menu. As a result, a user may make an operation on the setup menu. This confuses the user.

The present invention is attained in view of the above problems. An object of the present invention is to provide a display device, a transmission device, a display system, a method of controlling the display device, a method of controlling the transmission device, a control program and a storage medium, each of which makes it possible to appropriately display, on a display, an OSD such as a menu of each of the display and a connected apparatus that is connected to the display and that is capable of working with the display.

### Solution to Problem

In order to solve the above problems, a display device of the present invention receiving a video signal transmitted from a transmission device and displaying a video image represented by the video signal, the display device includes: display-side obtaining means obtaining transmitter-side OSD information indicative of a type of a transmitter-side OSD image superimposed by the transmission device on the video signal transmitted to the display device, the transmitter-side OSD information being notified by the transmission device; superimposition control means deciding whether or not to superimpose a display-side OSD image on the video signal to be displayed, in accordance with the type of the transmitter-side OSD image indicative of the transmitter-side OSD information obtained by the display-side obtaining means and a type of the display-side OSD image; and display-side superimposing means superimposing the display-side OSD image on the video signal received from the transmission device, in a case where the superimposition control means decides to superimpose the display-side OSD image.

Further, a method of the present invention for controlling a display device that receives a video signal transmitted from a transmission device and displays a video image represented by the video signal, the method includes the steps of: (a) obtaining transmitter-side OSD information indicative of a type of a transmitter-side OSD image superimposed by the transmission device on the video signal transmitted to the display device, the transmitter-side OSD information being notified by the transmission device; (b) deciding whether or not to superimpose a display-side OSD image on the video signal to be displayed, in accordance with the type of the transmitter-side OSD image indicative of the transmitter-side OSD information obtained in the step (a) and a type of the display-side OSD image; and (c) superimposing the display-side OSD image on the video signal received from the transmission device, in a case where superimposition of the display-side OSD image is decided in the step (b).

In order to solve the above problems, a transmission device of the present invention transmitting a video signal to a display device, the transmission device includes: transmitter-side superimposing means superimposing a transmitter-side OSD image on the video signal that is to be transmitted to the display device; and transmitter-side notification means notifying the display device of transmitter-side OSD information indicative of a type of the transmitter-side OSD image superimposed by the transmitter-side superimposing means.

Further, a method of the present invention for controlling a transmission device transmitting a video signal to a display device, the method includes the steps of: (d) superimposing a transmitter-side OSD image on the video signal that is to be transmitted to the display device; and (e) notifying the display device of transmitter-side OSD information indicative of a type of the transmitter-side OSD image superimposed in the step (d).

### Advantageous Effects of Invention

The above configuration makes it possible to appropriately display a menu that is an operation target. Accordingly, it is not necessary to decide an operation target at the time when an operation is to be made. This makes it possible to have a high operability.

### BRIEF DESCRIPTION OF DRAWINGS

FIG. 1 is a functional block diagram illustrating a schematic configuration of an OSD display system including a display device and a transmission device according to one embodiment of the present invention.

FIG. 2 is an explanatory view illustrating an overview of the OSD display system illustrated in FIG. 1.

FIG. 3 is a block diagram illustrating a hardware configuration of the transmission device and the display device of the OSD display system of FIG. 1.

FIG. 4 is a flow chart illustrating one example of a flow of a regular communication process among OSD display control processes in the OSD display system of FIG. 1.

FIG. 5 is a sequence diagram illustrating one example of a flow of a regular communication process among OSD display control processes in the OSD display system of FIG. 1.

FIG. 6 is a flow chart illustrating one example of a flow of an OSD image exclusive display process among OSD display control processes in the OSD display system of FIG. 1.

FIG. 7 is a sequence diagram illustrating one example of a flow of an OSD image exclusive display process among OSD display control processes in the OSD display system of FIG. 1.

FIG. 8 is a flow chart illustrating one example of a flow of a process at the time when communication is cut off during OSD image display carried out by the display device, among OSD display control processes in the OSD display system of FIG. 1.

FIG. 9 is a sequence diagram illustrating one example of a flow of a process at the time when communication is cut off during OSD image display carried out by the display device, among OSD display control processes in the OSD display system of FIG. 1.

FIG. 10 is a flow chart illustrating one example of a flow of a process at the time when communication is cut off during display of an OSD image of the transmission device, among OSD display control processes in the OSD display system of FIG. 1.

FIG. 11 is a sequence diagram illustrating one example of a flow of a process at the time when communication is cut off during display of an OSD image display of the transmission device, among OSD display control processes in the OSD display system of FIG. 1.

FIG. 12 illustrates one example of a definition table for simultaneous/exclusive display by OSD type to which definition table a superimposition control section of the display device of FIG. 1 makes reference.

FIG. 13 illustrates one example of a definition table for priority display by OSD type to which definition table a superimposition control section of the display device of FIG. 1 makes reference.

FIG. 14 is an explanatory diagram illustrating an example display of a full-screen OSD that is displayed by the display device of FIG. 1.

FIG. 15 is an explanatory diagram illustrating an example display of a video-image-containing OSD that is displayed by the display device.

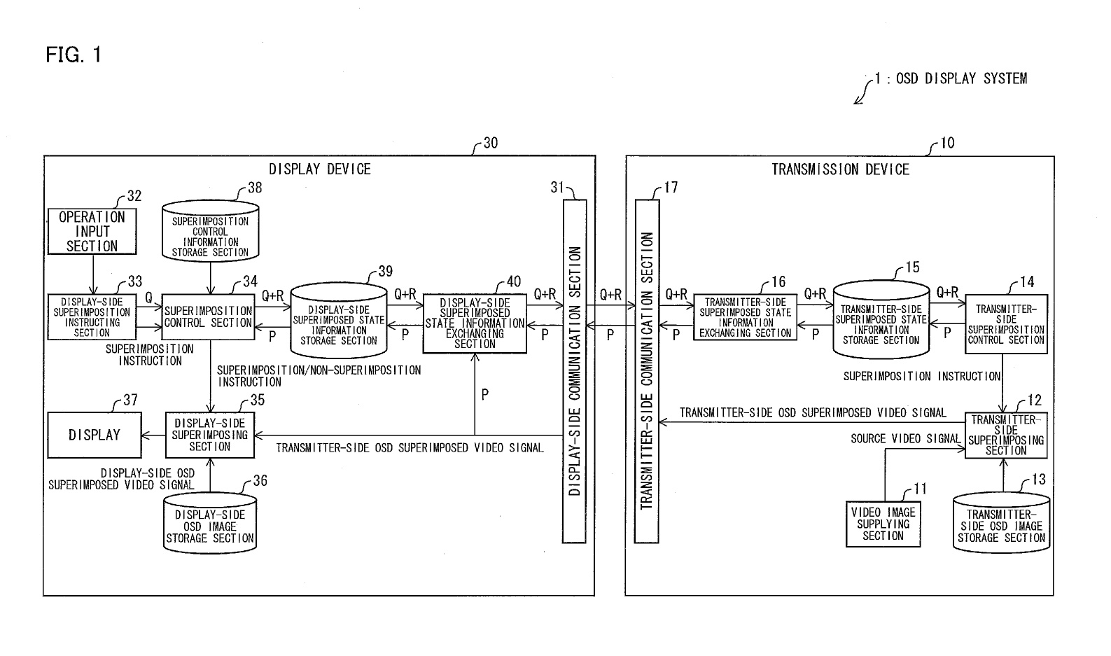

(a) to (c) of FIG. 16 are explanatory diagrams each illustrating an example display of a relatively small OSD image that is displayed by the display device illustrated in FIG. 1.

### DESCRIPTION OF EMBODIMENTS

The following discusses one embodiment of the present invention in detail, with reference to FIGS. 1 to 16.

[Overview of OSD Display System 1]

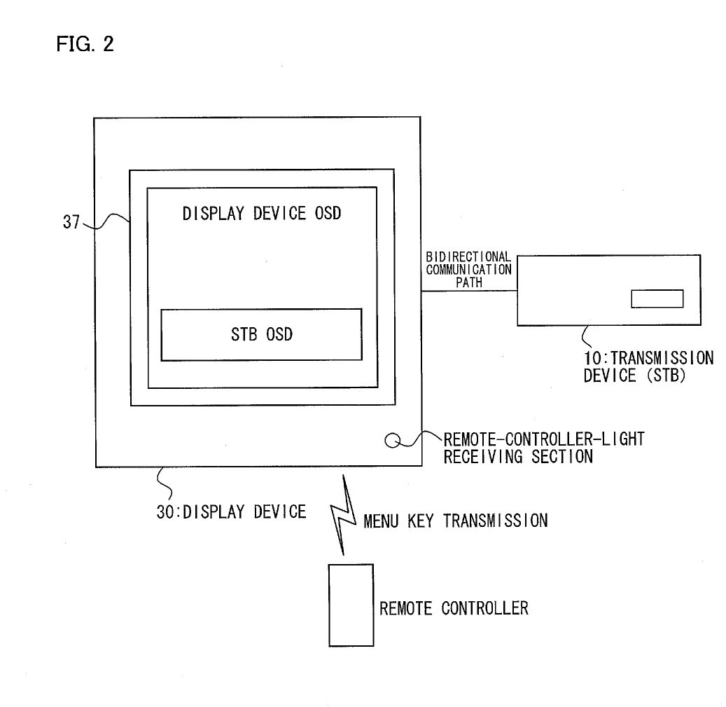

FIG. 2 is an explanatory view illustrating an overview of an OSD display system (display system) 1 according to the present embodiment.

As illustrated in FIG. 2, the OSD display system 1 includes a transmission device 10 and a display device 30 that are communicably connected via a bidirectional communication path. The transmission device 10 transmits a transmitter-side OSD superimposed video signal (video signal) to the display device 30. The display device 30 receives the transmitter-side OSD superimposed video signal (video signal) transmitted from the transmission device 10 and displays a video image represented by the transmitter-side OSD superimposed video signal (video signal). Here, the display device 30 obtains, particularly, a type of a transmitter-side OSD image which the transmitter device 10 has superimposed on the transmitter-side OSD superimposed video signal. Then, in accordance with thus obtained type of the transmitter-side OSD image and a type of a display-side OSD image, the display device 30 decides whether or not to superimpose the display-side OSD image on a display-side OSD superimposed video signal (video signal) that is to be displayed on a display 37.

FIG. 2 illustrates a state where: the transmission device 10 that is an STB transmits the transmitter-side OSD superimposed video signal where the transmitter-side OSD image is superimposed, to the display device 30 via the bidirectional communication path; and the display device 30 displays an image on the display 37 by use of the display-side OSD superimposed video signal generated by further superimposing the display-side OSD image on the video signal received from the transmission device 10. FIG. 2 illustrates a state where the display device 30 simultaneously displays the transmitter-side OSD image and the display-side OSD image as a result of determination based on a combination of the type of the transmitter-side OSD image and the type of the display-side OSD image.

Here, the transmitter-side OSD image is an image for displaying a menu for allowing a user to operate the transmission device 10, a warning, and/or the like. Further, the display-side OSD image is an image for displaying a menu for allowing a user to operate the display device 30, a warning, and/or the like.

[Configuration of Transmission Device 10 and Display Device 30]

FIG. 1 is a functional block diagram illustrating a schematic configuration of the OSD display system 1 including the transmission device 10 and the display device 30.

As illustrated in FIG. 1, the OSD display system 1 includes the transmission device 10 and the display device 30 that are communicably connected. Note that, in the present specification, the term “transmitter-side” is given to functional blocks in the transmission device 10, information generated by the transmission device 10, and the like, so as to indicate “transmission device 10 side”. Meanwhile, the term “display-side” is given to functional blocks in the display device 30, information generated by the display device 30, and the like, so as to indicate “display device 30 side”.

The transmission device 10 is configured to include a video image supplying section 11, a transmitter-side superimposing section (transmitter-side superimposing means) 12, a transmitter-side OSD image storage section 13, a transmitter-side superimposition control section 14, a transmitter-side superimposed state information storage section (transmitter-side OSD information storage section) 15, a transmitter-side superimposed state information exchanging section (transmitter-side notification means, transmitter-side obtaining means) 16, and a transmitter-side communication section 17.

The video image supplying section 11 obtains a source video signal, and supplies this source video signal to the transmitter-side superimposing section 12. Note that the source video signal in the present embodiment is not limited to video signals supplied from broadcasting sources such as a digital terrestrial broadcasting source, a CS broadcasting source, and a BS broadcasting source. Examples of the source video signal encompass video signals supplied from, for example, communication sources such as IPTV and VOD, medium sources such as a hard disk drive and an optical disk drive and application sources such as a web browser and a USB application (an application for reproducing contents stored in a USB memory). Further, the source video signal is not limited to a video signal representing a moving image but may be a video signal representing a static image. Furthermore, the video signal may be a video signal representing a UI (user interface) like video signals supplied from application sources.

The transmitter-side superimposition control section 14 requests the transmitter-side superimposing section 12 to superimpose a transmitter-side OSD image on the source video signal, in response to an event such as a user operation.

In accordance with a superimposition instruction from the transmitter-side superimposition control section 14, the transmitter-side superimposing section 12 obtains, from the transmitter-side OSD image storage section 13, the transmitter-side OSD image whose superimposition is instructed, and superimposes the transmitter-side OSD image on a transmitter-side OSD superimposed video signal. Note that in the transmitter-side OSD image storage section 13, the transmitter-side OSD image to be superimposed by the transmitter-side superimposing section 12 is stored in advance. The transmitter-side OSD image may be stored, in the transmitter-side OSD image storage section 13, in the form of image data, or character data or the like that is convertible into an image at the time when the transmitter-side superimposing section 12 superimposes the transmitter-side OSD image.

The transmitter-side superimposed state information storage section 15 stores transmitter-side OSD information P indicative of a type of the transmitter-side OSD image which the transmitter-side superimposition control section 14 has instructed to superimpose. Further, the transmitter-side superimposed state information storage section 15 stores display-side OSD information Q and display state information R that are obtained from the display device 30 by the transmitter-side superimposed state information exchanging section 16.

The transmitter-side superimposed state information exchanging section 16 notifies the display device 30 of the transmitter-side OSD information P indicative of the type of the transmitter-side OSD image superimposed by the transmitter-side superimposing section 12. Further, the transmitter-side superimposed state information exchanging section 16 regularly obtains display-side OSD information Q indicative of a type of a display-side OSD image whose superimposition on a transmitter-side OSD superimposed video signal is requested in the display device 30 and display state information R indicative of an OSD image that is actually displayed on the display 37. Further, the transmitter-side superimposed state information exchanging section 16 regularly transmits, to the display device 30, transmitter-side OSD information P indicative of a type of a transmitter-side OSD image which is superimposed on a transmitter-side OSD superimposed video signal that is most recently transmitted from the transmission device 10 to the display device 30.

Furthermore, the transmitter-side superimposed state information exchanging section 16 erases the display-side OSD information Q and the display state information R that are stored in the transmitter-side superimposed state information storage section 15, when communication with the display device 30 is cut off. Note that the transmitter-side superimposed state information exchanging section 16 may also erase the transmitter-side OSD information P together with the display-side OSD information Q and the display state information R.

The transmitter-side communication section 17 is an interface for communicating with the display device 30, wirelessly or by use of wires.

Meanwhile, the display device 30 is configured to include a display-side communication section 31, an operation input section 32, a display-side superimposition instructing section (superimposition requesting means) 33, a superimposition control section (superimposition control means) 34, a display-side superimposing section (display-side superimposing means) 35, a display-side OSD image storage section 36, the display 37, a superimposition control information storage section 38, a display-side superimposed state information storage section (display-side OSD information storage section) 39, and a display-side superimposed state information exchanging section (display-side obtaining means, display-side notification means) 40.

The display-side communication section 31 is an interface for communicating with the transmission device 10, wirelessly or by use of wires.

The operation input section 32 is an interface for obtaining a user operation input via a remote controller or a button.

The display-side superimposition instructing section 33 requests the superimposition control section 34 to superimpose a display-side OSD image on the transmitter-side OSD superimposed video signal, in response to an event such as a user operation obtained by the operation input section 32.

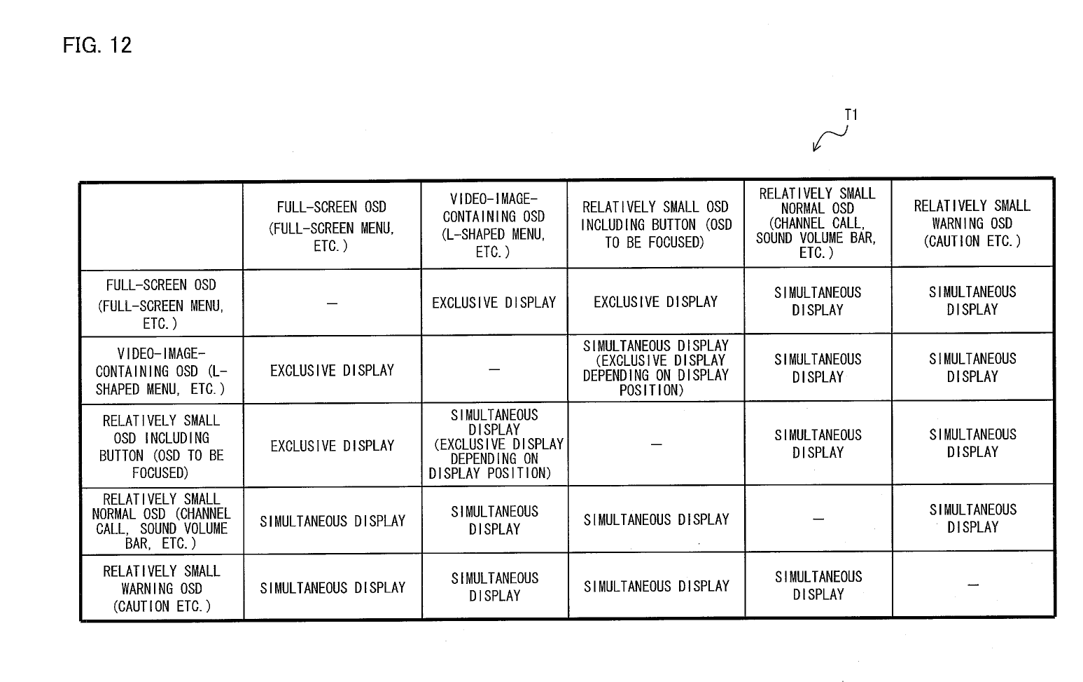

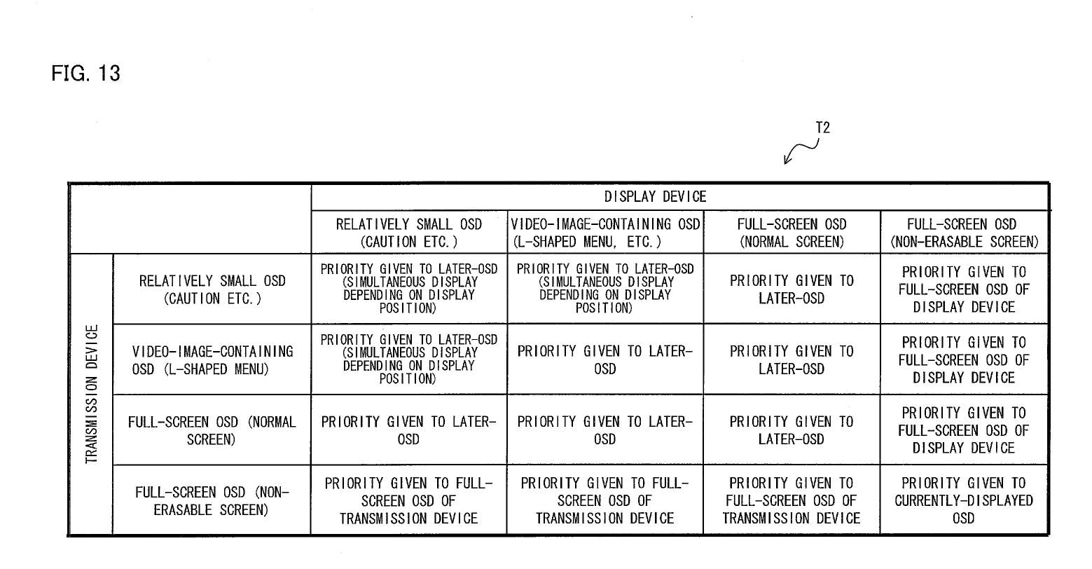

The superimposition control section 34 decides whether or not to superimpose the display-side OSD image on a display-side OSD superimposed video signal to be displayed on the display 37. This decision is made in accordance with the type of the display-side OSD image and the type of the transmitter-side OSD image of the transmitter-side OSD information P that has been obtained by the display-side superimposed state information exchanging section 40. When this decision is made, the superimposition control section 34 makes reference to a definition table T1 (FIG. 12) for simultaneous/exclusive display by OSD type and a definition table T2 (FIG. 13) for priority display by OSD type. The definition table T1 and the definition table T2 are stored in the superimposition control information storage section 38. Note that details of a method of making such a decision will be discussed later.

In a case where the superimposition control section 34 decides to superimpose the display-side OSD image, the display-side superimposing section 35 superimposes the display-side OSD image onto the transmitter-side OSD superimposed video signal received from the transmission device 10, and thereby generates the display-side OSD superimposed video signal. In other words, having received a superimposition instruction from the superimposition control section 34, the display-side superimposing section 35 obtains, from the display-side OSD image storage section 36, the display-side OSD image whose superimposition is instructed. Then, the display-side superimposing section 35 superimposes this display-side OSD image onto the display-side OSD superimposed video signal. On the other hand, having received a non-superimposition instruction from the superimposition control section 34, the display-side superimposing section 35 does not superimpose the display-side OSD image but outputs, as the display-side OSD superimposed video signal, the transmitter-side OSD superimposed video signal directly as received. Note that the display-side OSD image that is to be superimposed by the display-side superimposing section 35 is stored in advance in the display-side OSD image storage section 36. The display-side OSD image may be stored, in the display-side OSD image storage section 36, in the form of image data, or character data or the like that is convertible into an image at the time when the display-side superimposing section 35 superimposes the display-side OSD image.

The display 37 is a display device such as LCD that displays a video image in accordance with a video signal.

The display-side superimposed state information storage section 39 is caused to store the transmitter-side OSD information P that is indicative of the type of the transmitter-side OSD image superimposed on the transmitter-side OSD superimposed video signal and that is obtained by the display-side superimposed state information exchanging section 40 from the transmitter-side OSD superimposed video signal having been received from the transmission device 10. The display-side superimposed state information storage section 39 is also caused to store the display-side OSD information Q indicative of the type of the display-side OSD image which the display-side superimposition instructing section 33 has instructed the superimposition control section 34 to superimpose. Furthermore, the display-side superimposed state information storage section 39 is caused to store the display state information R indicative of the OSD image that is actually displayed on the display 37 according to the decision of the superimposition control section 34.

Having received the transmitter-side OSD superimposed video signal from the transmission device 10, the display-side superimposed state information exchanging section 40 extracts and obtains the transmitter-side OSD information P contained in the transmitter-side OSD superimposed video signal. This transmitter-side OSD information P is indicative of the type of the transmitter-side OSD image superimposed by the transmission device 10 on the transmitter-side OSD superimposed video signal. The transmitter-side OSD information P is contained in the transmitter-side OSD superimposed video signal and transmitted from the transmission device 10.

Further, the display-side superimposed state information exchanging section 40 regularly (e.g., after every standby period of approximately 2 to 3 seconds) obtains transmitter-side OSD information P indicative of a type of a transmitter-side OSD image superimposed on a transmitter-side OSD superimposed video signal that is most recently transmitted from the transmission device 10 to the display device 30. Then, the display-side superimposed state information exchanging section 40 updates the transmitter-side OSD information P stored in the display-side superimposed state information storage section 39 by use of thus obtained transmitter-side OSD information P. Further, the display-side superimposed state information exchanging section 40 notifies display-side OSD information Q and display state information R to the transmission device 10 regularly or at the time when display of the display 37 changes.

Further, the display-side superimposed state information exchanging section 40 erases the transmitter-side OSD information P stored in the display-side superimposed state information storage section 39 at the time when communication with the transmission device 10 is cut off. Note that the display-side superimposed state information exchanging section 40 may also erase the display-side OSD information Q and the display state information R together with the transmitter-side OSD information P.

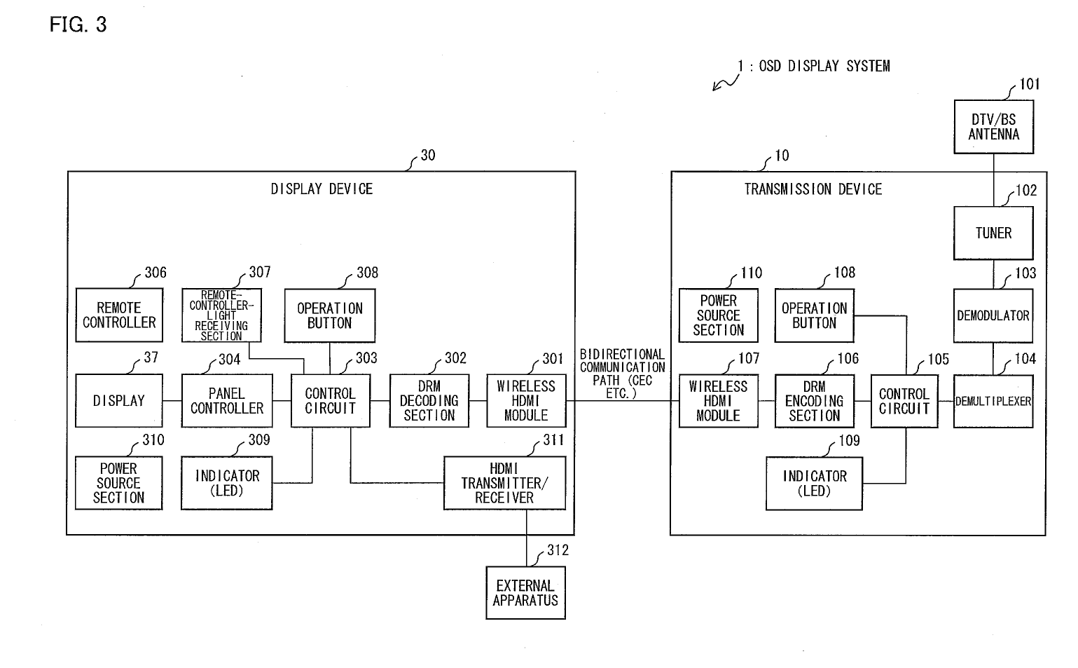

FIG. 3 is a block diagram illustrating a hardware configuration of the transmission device 10 and the display device 30 of the OSD display system 1.

As illustrated in FIG. 3, the transmission device 10 is configured to include a DTV/BS antenna 101, a tuner 102, demodulator 103, a demultiplexer 104, a control circuit 105, a DRM encoding section 106, a wireless HDMI module 107, an operation button 108, an indicator 109, and a power source section 110. Further, the transmission device 10 includes a storage section (not illustrated) such as a memory for storing data used in OSD display control processing according the present embodiment.

Meanwhile, the display device 30 is configured to include a wireless HDMI module 301, a DRM decoding section 302, a control circuit 303, a panel controller 304, a display 37, a remote controller 306, a remote controller light receiving section 307, an operation button 308, an indicator 309, a power source section 310, and an HDMI transmitter/receiver 311. To the HDMI transmitter/receiver 311, an external apparatus 312 may be connected. Further, the display device 30 includes a storage section (not illustrated) such as a memory for storing data used in OSD display control processing according the present embodiment.

The transmission device 10 and the display device 30 are communicably connected to each other via a bidirectional communication path, by use of the wireless HDMI module 107 and the wireless HDMI module 301.

Then, the transmitter-side superimposing section 12, the transmitter-side superimposition control section 14, and the transmitter-side superimposed state information exchanging section 16 of the transmission device 10 as illustrated in FIG. 1 are realized by the control circuit 105 as illustrated in FIG. 3 and a peripheral circuit of the control circuit 105. Further, the video image supplying section 11 as illustrated in FIG. 1 corresponds to the DTV/BS antenna 101, the tuner 102, the demodulator 103, and the demultiplexer 104 as illustrated in FIG. 3. The transmitter-side communication section 17 as illustrated in FIG. 1 corresponds to the wireless HDMI module 107 as illustrated in FIG. 3.

Further, the display-side superimposition instructing section 33, the superimposition control section 34, the display-side superimposing section 35, and the display-side superimposed state information exchanging section 40 of the display device 30 as illustrated in FIG. 1 is realized by the control circuit 303 as illustrated in FIG. 3 and a peripheral circuit of the control circuit 303. In addition, the display-side communication section 31 as illustrated in FIG. 1 corresponds to the wireless HDMI module 301 as illustrated in FIG. 3. The operation input section 32 as illustrated in FIG. 1 corresponds to the remote controller 306, the remote controller light receiving section 307, and the operation button 308 as illustrated in FIG. 3.

Next, the following discusses a flow of an OSD display control process in the OSD display system 1.

[Flow of Regular Communication Process]

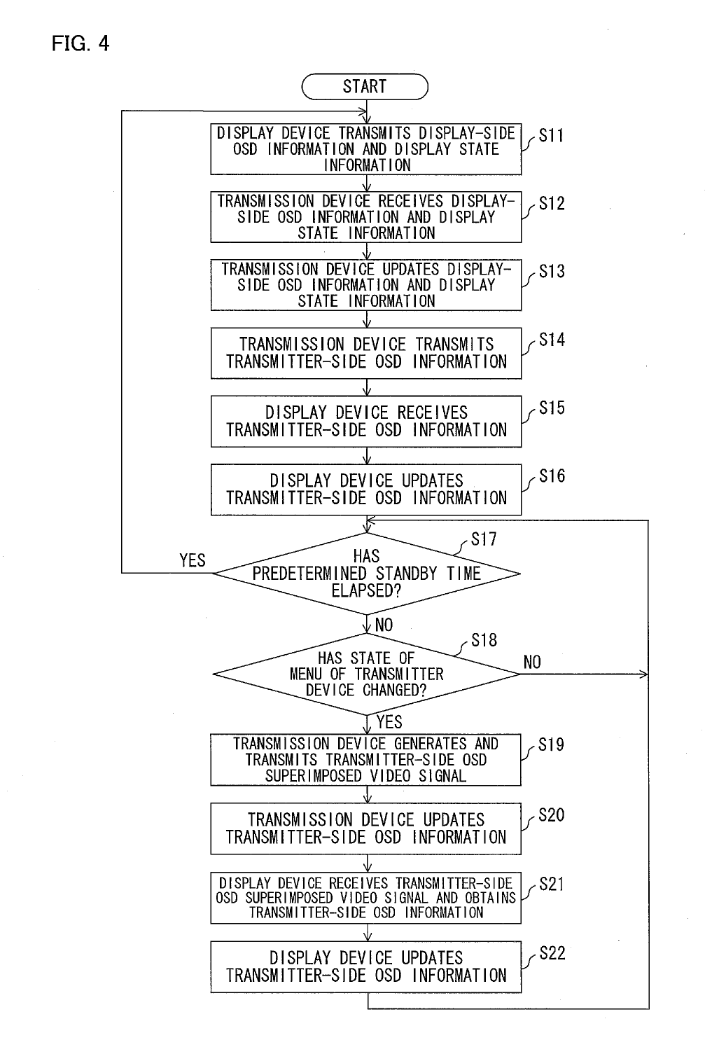

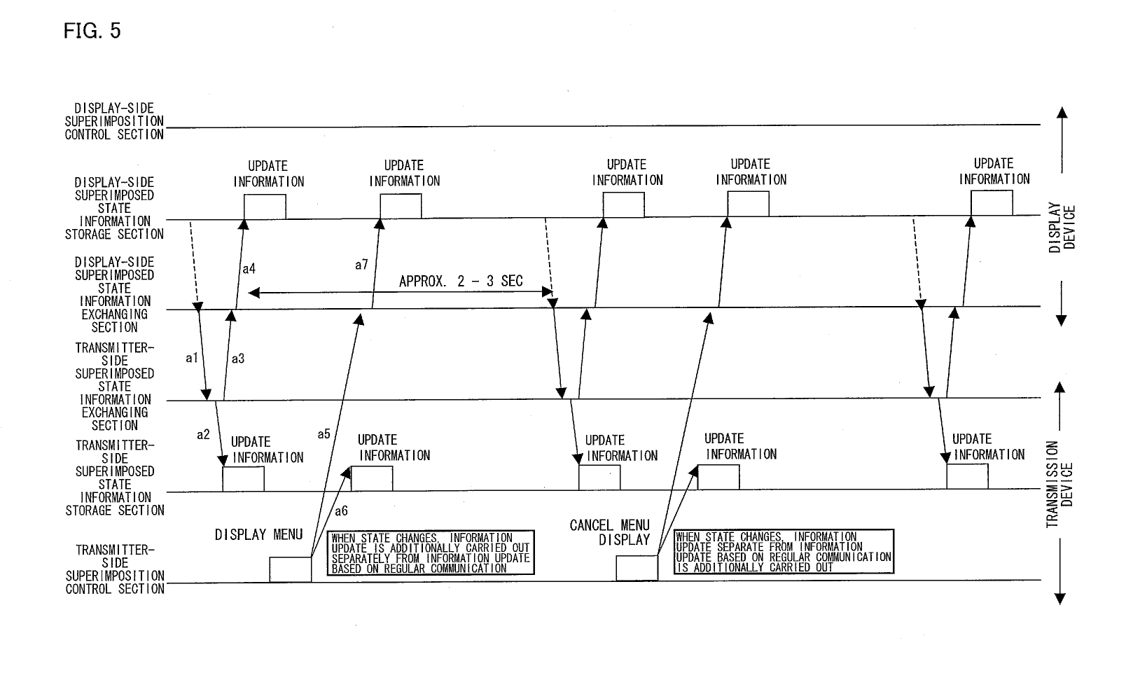

FIG. 4 is a flow chart illustrating one example of a flow of a regular communication process among OSD display control processes in the OSD display system 1. FIG. 5 is a sequence diagram illustrating one example of the flow of the regular communication process among OSD display control processes in the OSD display system 1.

First, in the display device 30, the display-side superimposed state information exchanging section 40 transmits, to the transmission device 10, display-side OSD information Q and display state information R of the display device 30 that are stored in the display-side superimposed state information storage section 39 (S11; a1). Then, in the transmission device 10, the transmitter-side superimposed state information exchanging section 16 receives the display-side OSD information Q and the display state information R transmitted (S12). Next, the transmitter-side superimposed state information exchanging section 16 updates display-side OSD information Q and display state information R that are stored in the transmitter-side superimposed state information storage section 15 (S13; a2).

Meanwhile, in the transmission device 10, the transmitter-side superimposed state information exchanging section 16 transmits, to the display device 30, transmitter-side OSD information P (menu state) of the transmission device 10 that is stored in the transmitter-side superimposed state information storage section 15, having received the display-side OSD information Q and the display state information R (S14 (transmitter-side notification step); a3). Then, in the display device 30, the display-side superimposed state information exchanging section 40 receives thus transmitted transmitter-side OSD information P (S15 (display-side obtaining step)). Next, the display-side superimposed state information exchanging section 40 updates transmitter-side OSD information P stored in the display-side superimposed state information storage section 39 (S16; a4).

The OSD display system 1 repeatedly executes processing of the above steps S11 to S16, after every predetermined standby period (approximately 2 to 3 seconds) (YES in S17).

Further, in the OSD display system 1, when a menu state in the transmission device 10 changes (YES in S18), additional OSD information update is carried out separately from the above regular communication process (S11 through S16). More specifically, in the transmission device 10, under the control of the transmitter-side superimposition control section 14, the transmitter-side superimposing section 12 superimposes an OSD image stored in the transmitter-side OSD image storage section 13 onto the source video signal obtained from the video image supplying section 11 so as to generate a transmitter-side OSD superimposed video signal (transmitter-side superimposition step, the step of superimposing a transmitter-side OSD image). Next, the transmitter-side superimposing section 12 transmits the transmitter-side OSD superimposed video signal to the display device 30 via the transmitter-side communication section 17 (S19 (transmitter-side notification step); a5). At this time, in generation of the transmitter-side OSD superimposed video signal by superimposition of the OSD image on the source video signal, the transmitter-side superimposing section 12 puts transmitter-side OSD information P indicative of a type of the OSD image in the transmitter-side OSD superimposed video signal and then transmits this transmitter-side OSD superimposed video signal. Simultaneously, in the transmission device 10, the transmitter-side superimposition control section 14 updates the transmitter-side OSD information P stored in the transmitter-side superimposed state information storage section 15, by use of the transmitter-side OSD information P indicative of the type of the OSD image which the transmitter-side superimposition control section has instructed the transmitter-side superimposing section 12 to superimpose (S20; a6).

Further, in the display device 30 having received the transmitter-side OSD superimposed video signal from the transmission device 10, the display-side superimposed state information exchanging section 40 obtains the transmitter-side OSD information P from the transmitter-side OSD superimposed video signal (S21 (display-side obtaining step)). Then, the display-side superimposed state information exchanging section 40 updates, by use of the transmitter-side OSD information P, the transmitter-side OSD information P stored in the display-side superimposed state information storage section 39 (S22; a7).

Similarly, when a menu state changes in the display device 30, the display-side OSD information Q and the display state information R are updated. In other words, the display-side superimposed state information exchanging section 40 of the display device 30 transmits, to the transmission device 10, display-side OSD information Q and display state information R that are updated and stored in the display-side superimposed state information storage section 39. Next, the transmitter-side superimposed state information exchanging section 16 of the transmission device 10 having received the OSD information Q and the display state information R updates the display-side OSD information Q and the display state information R that are stored in the transmitter-side superimposed state information storage section 15.

[Flow of OSD Image Exclusive Display Process]

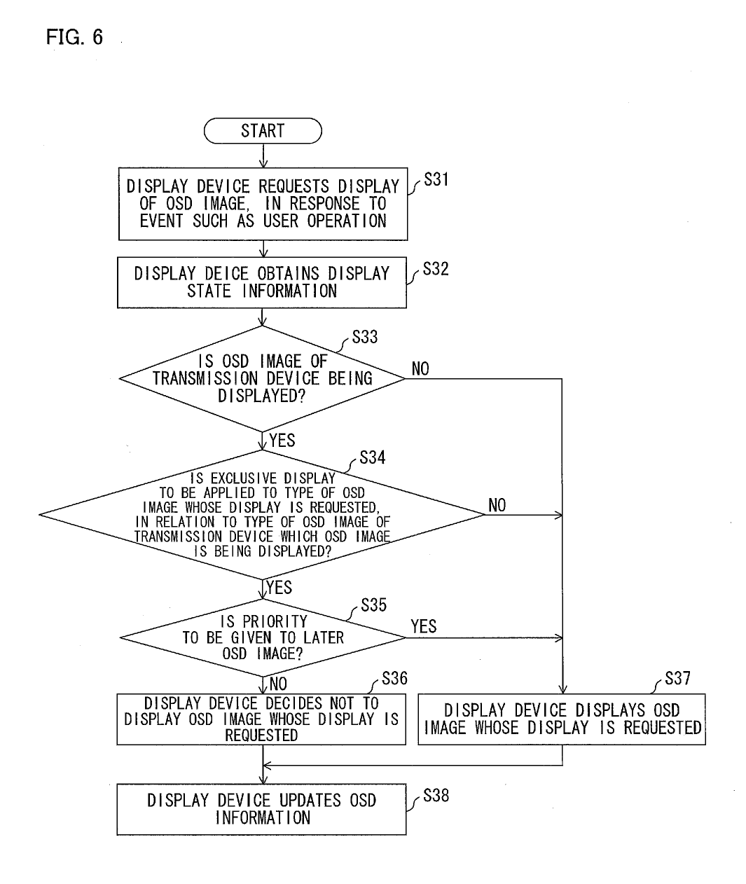

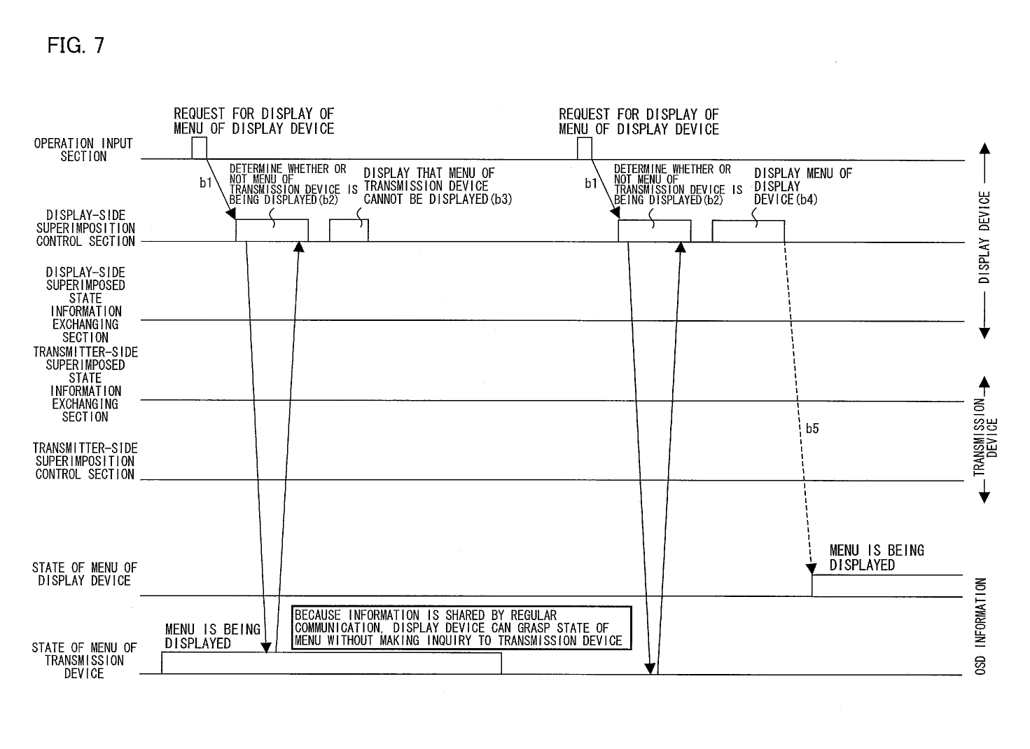

FIG. 6 is a flow chart illustrating one example of a flow of an OSD image exclusive display process among OSD display control processes in the OSD display system 1. FIG. 7 is a sequence diagram illustrating one example of the flow of the OSD image exclusive display process.

In the display device 30, when display of an OSD image is required, in response to an event, such as a user operation, that is obtained by the operation input section 32, the display-side superimposition instructing section 33 requests the superimposition control section 34 to display the OSD image (S31; b1). At this time, the superimposition control section 34 obtains display state information R indicative of a state of an OSD image being displayed on the display 37, from the display-side superimposed state information storage section 39 (S32). Then, the superimposition control section 34 determines whether or not an OSD image of the transmission device 10 is being displayed (S33; b2).

In a case where the OSD image of the transmission device 10 is being displayed (YES in S33), the superimposition control section 34 determines whether a type of the OSD display whose display is requested by the display-side superimposition instructing section 33 is a type that is to be subjected to exclusive display in relation to the type of the OSD image of the transmission device 10 which OSD image is currently being displayed (S34 (superimposition control step)). Note that this determination is made with reference to a table (the definition table T1 (FIG. 12) for simultaneous/exclusive display by OSD type) stored in the superimposition control information storage section 38.

Then, in a case where the type of the OSD image whose display is requested by the display-side superimposition instructing section 33 is a type that is to be subjected to exclusive display, in relation to the type of the OSD image of the transmission device 10 (YES in S34), the superimposition control section 34 determines whether or not the OSD image is of a type that gives priority to a later OSD (S35 (superimposition control step)). Note that this determination is made with reference to a table (the definition table T2 (FIG. 13) for priority display by OSD type) stored in the superimposition control information storage section 38.

In a case where the OSD display whose display is requested by the display-side superimposition instructing section 33 is not of the type that gives priority to a later OSD or a type that gives priority to an OSD of the display device (NO in S35), the superimposition control section 34 determines not to display the OSD image whose display is requested by the display-side superimposition instructing section 33. At this time, it may be displayed that the OSD image whose display is request cannot be displayed (S36; b3).

Meanwhile, in a case where the OSD image of the transmission device 10 is not being displayed (NO in S33), in a case where the type of the OSD image whose display is requested by the display-side superimposition instructing section 33 is not of the type that is to be subjected to exclusive display, in relation to the type of the OSD image of the transmission device 10 (NO in S34), or in a case where the type of the OSD image whose display is requested is of the type that gives priority to a later OSD or the type that gives priority to an OSD of the display device (YES in S36), the superimposition control section 34 causes the display-side superimposing section 35 to superimpose the OSD image on the transmitter-side OSD superimposed video signal so as to generate a display-side OSD superimposed video signal so that the OSD image whose display is requested by the display-side superimposition instructing section 33 is displayed, and then causes the display 37 to display the OSD image (S37 (display-side superimposition process)).

Here, as a result of the above determination, OSD information stored in the display-side superimposed state information storage section 39 is updated regardless of whether or not the OSD image whose display is requested by the display-side superimposition instructing section 33 is displayed on the display 37. More specifically, in a case where the OSD image whose display is requested by the display-side superimposition instructing section 33 is not displayed on the display 37, display-side OSD information Q is updated in accordance with a type of the OSD image. Meanwhile, in a case where the OSD image whose display is requested by the display-side superimposition instructing section 33 is displayed on the display 37, display state information R as well as the display-side OSD information Q is updated by use of information indicating that the OSD image of the display device 30 is being displayed (S38; b5).

Next, the following discusses a flow of a process at the time when communication is cut off during OSD image display carried out by the display device 30, among OSD display control processes in the OSD display system 1.

[Flow of Process at the Time when Communication is Cut Off During OSD Image Display Carried Out by Display Device 30]

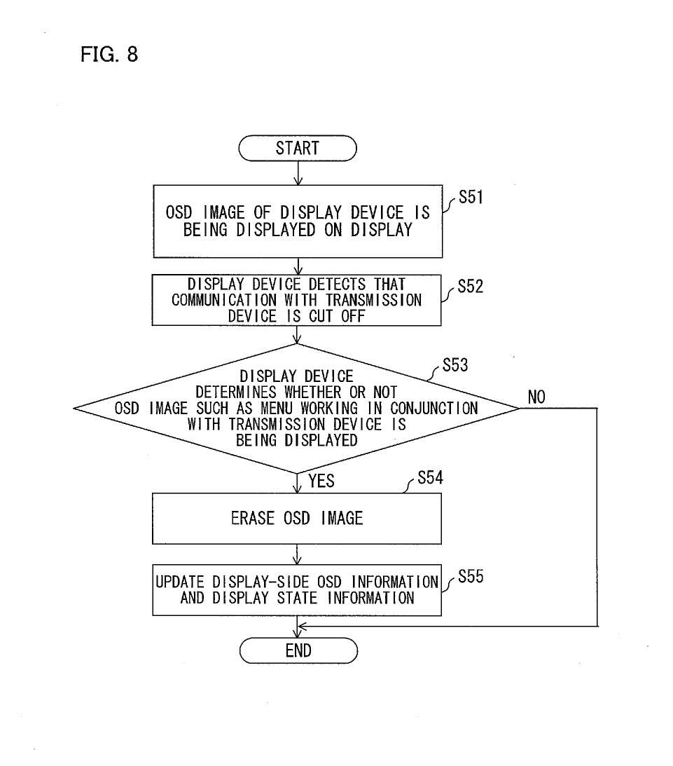

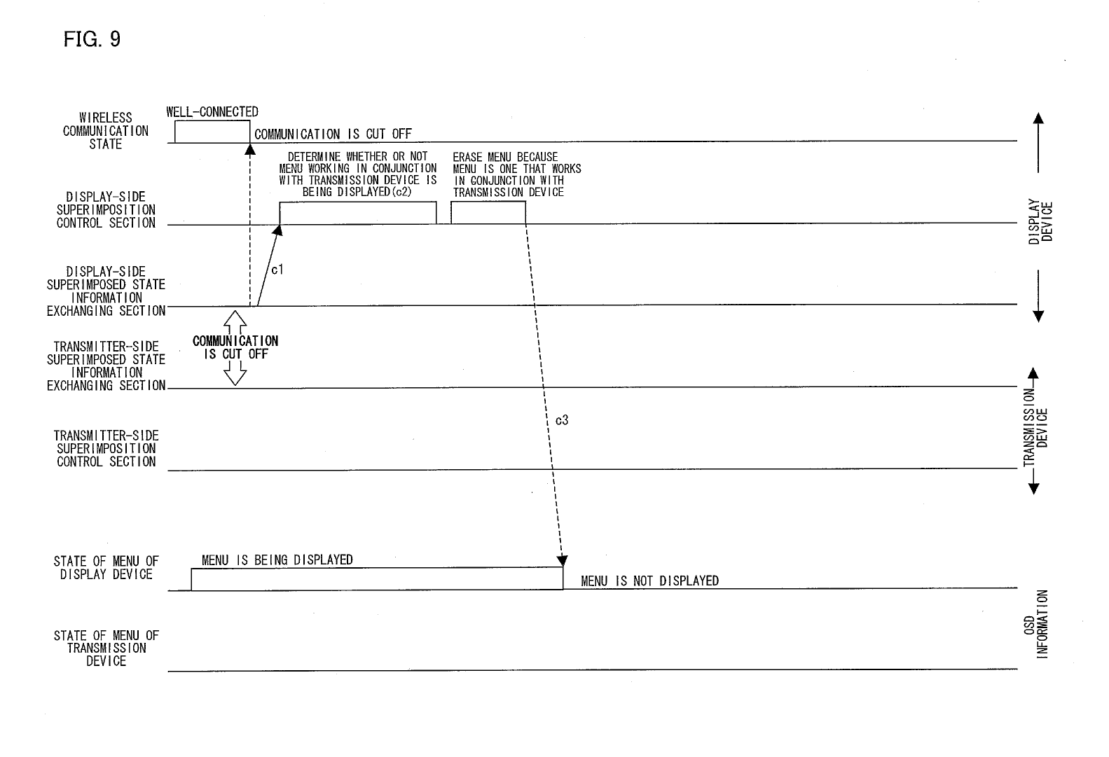

FIG. 8 a flow chart illustrating one example of a flow of a process at the time when communication is cut off during OSD image display carried out by the display device 30, among OSD display control processes in the OSD display system 1. FIG. 9 is a sequence diagram illustrating one example of the flow of the process at the time when communication is cut off.

In a case where the display-side communication section 31 detects that communication with the transmission device 10 is cut off (S52; c1) while the OSD image of the display device 30 is being displayed on the display 37 (S51), the superimposition control section 34 of the display device 30 determines whether or not an OSD image, such as a menu, that works with the transmission device 10 is being displayed (S53; c2). Then, in a case where the OSD image working with the transmission device 10 is being displayed (YES in S53), the superimposition control section 34 erases the OSD image (S54). More specifically, the superimposition control section 34 causes the display-side superimposing section 35 to generate a display-side OSD superimposed video signal based on a transmitter-side OSD superimposed video signal so that the OSD image is not displayed, and then causes the display 37 to carry out display.

Subsequently, display-side OSD information Q and display state information R are updated in accordance with the display-side OSD superimposed video signal newly generated (S55; c3).

[Flow of Process of Transmission Device 10 at the Time when Communication is Cut Off During OSD Image Display]

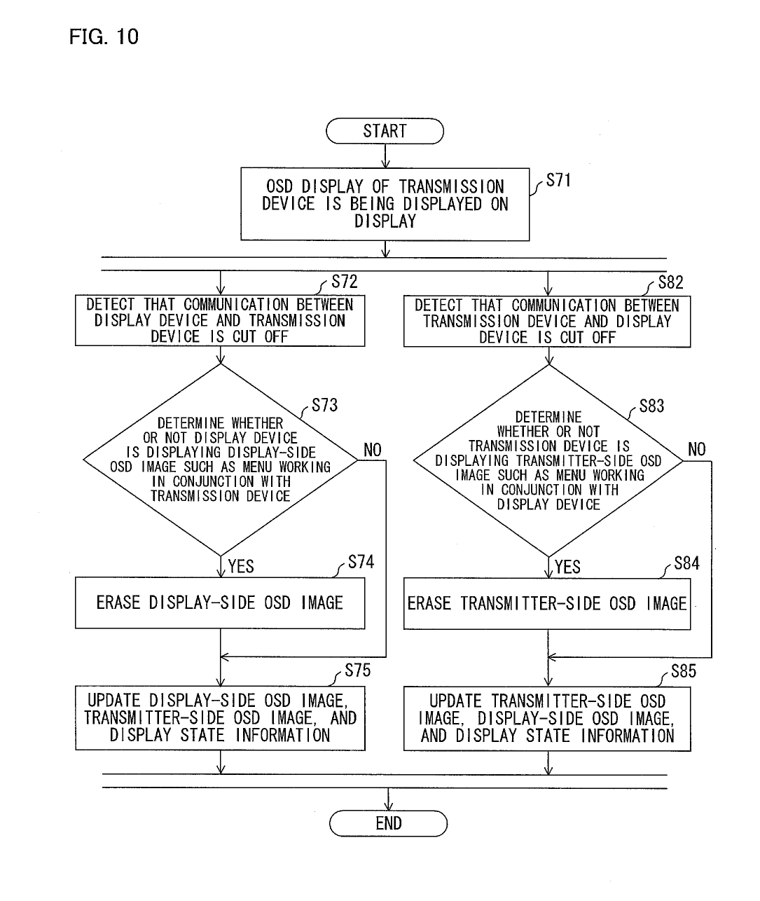

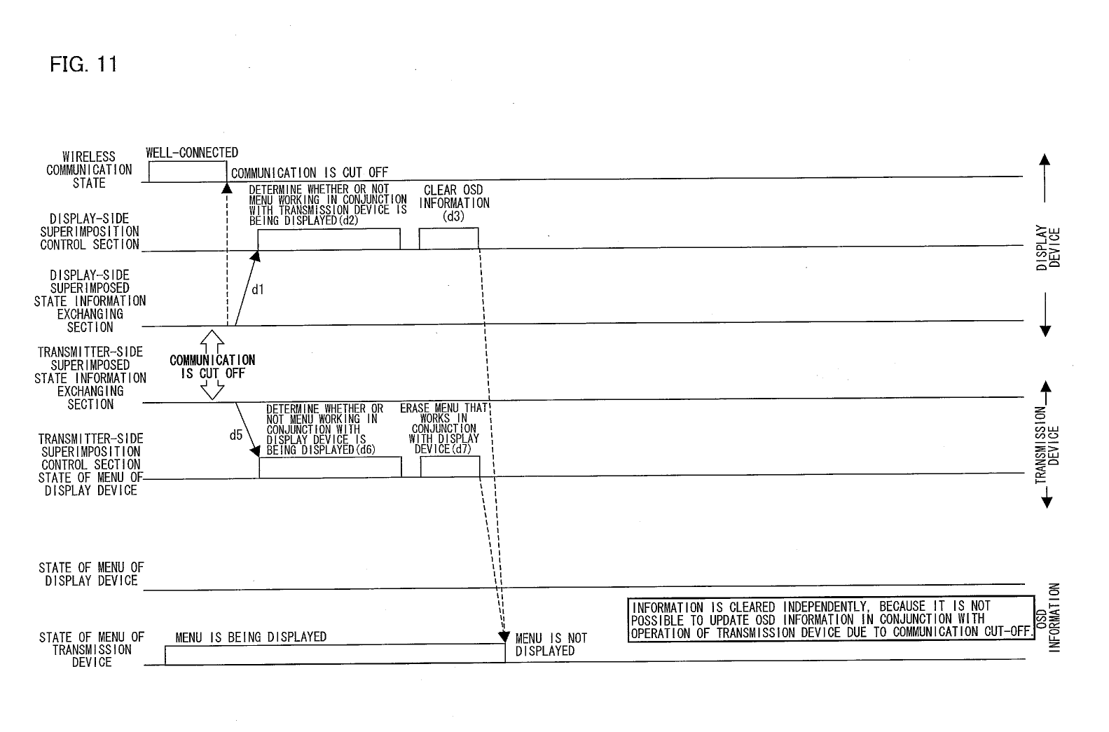

FIG. 10 is a flow chart illustrating one example of a flow of a process of the transmission device 10 at the time when communication is cut off during OSD image display, among OSD display control processes in the OSD display system 1. FIG. 11 is a sequence diagram illustrating one example of the flow of the process at the time when communication is cut off.

In a case where the display-side communication section 31 detects that communication with the transmission device 10 is cut off (S72; d1) while the OSD image of the transmission device 10 is being displayed on the display 37 (S71), the superimposition control section 34 of the display device 30 determines whether or not a display-side OSD image, such as a menu, that works with the transmission device 10 is being displayed (S73; d2). Then, in a case where the OSD image working with the transmission device 10 is being displayed (YES in S73), the superimposition control section 34 erases the display-side OSD image (S74). More specifically, the superimposition control section 34 causes the display-side superimposing section 35 to generate a display-side OSD superimposed video signal based on a transmitter-side OSD superimposed video signal so that the display-side OSD image is not displayed, and then causes the display 37 to carry out display. Note that due to cut-off of communication, the display device no longer receives any transmitter-side OSD superimposed video signal on which the transmitter-side OSD image is superimposed, and as a result, display of the transmitter-side OSD image is not carried out on the display 37.

Subsequently, information stored in the display-side superimposed state information storage section 39 is updated (S75; d3). More specifically, transmitter-side OSD information P is updated to “non-display”. Further, in a case where the display-side OSD image is erased, display-side OSD information Q is updated to “non-display”. Then, accordingly, display state information R is updated. Note that in a case where the display 37 is caused to have a black screen at the time when no transmitter-side OSD superimposed video signal is received, display-side OSD information Q is also updated to “non-display”.

Meanwhile, in a case where the transmitter-side communication section 17 detects that communication with the display device 30 is cut off (S82; d5) while the OSD image of the transmission device 10 is being displayed on the display 37 of the display device 30 (S71), the transmitter-side superimposition control section 14 determines whether or not a transmitter-side OSD image, such as a menu, that works with the display device 30 is being displayed (S83; d6). Then, in a case where the transmitter-side OSD image that works with the display device 30 is being displayed (YES in S83), the transmitter-side superimposition control section 14 erases the transmitter-side OSD image (S84). More specifically, the transmitter-side superimposition control section 14 causes the transmitter-side superimposing section 12 to generate and output a transmitter-side OSD superimposed video signal based on a source video signal so that the transmitter-side OSD image is not displayed.

Subsequently, information stored in the transmitter-side superimposed state information storage section 15 is updated (S85; d7). More specifically, in a case where the transmitter-side OSD image is erased, transmitter-side OSD information P is updated to “non-display”. Further, display-side OSD information Q is updated to “non-display”. Then, accordingly, display state information R is also updated.

As described above, in the display device 30 and the transmission device 10 that are wirelessly connected to each other, a different operation is carried out depending on whether the transmitter-side OSD image or the display-side OSD image is being displayed on the display 37 at the time when wireless connection is cut off.

In a case where communication is cut off during display of the transmitter-side OSD image on the display 37, the display device 30 receives no transmitter-side OSD superimposed video signal from the transmission device 10, and turns into a no-signal state. Accordingly, in general, a screen of the display 37 becomes black. Certainly, it is alternatively possible to display only the display-side OSD image on the display 37. At this time, in the display device 30, only the transmitter-side OSD information P and the display state information R are updated. More specifically, the display-side superimposed state information exchanging section 40 shifts a display state of the transmitter-side OSD image to a “non-display” state. Meanwhile, in the transmission device 10, the transmitter-side superimposition control section 14 determines whether or not to erase the transmitter-side OSD image. Then, in a case where the transmitter-side superimposition control section 14 determines that it is necessary to erase the transmitter-side OSD image, the transmitter-side superimposition control section 14 not only erases the transmitter-side OSD image but also updates the transmitter-side OSD information P and the display state information R.

Meanwhile, in a case where communication is cut off during display of the display-side OSD image on the display 37, only the display-side OSD information Q and the display state information R are updated in the transmission device 10. More specifically, the transmitter-side superimposed state information exchanging section 16 shifts a display state of the display-side OSD image to a “non-display” state. Further, in the display device 30, the display-side superimposition specifying section 33 determines whether or not to erase the display-side OSD image. Then, in a case where the display-side superimposition instructing section 33 determines that it is necessary to erase the display-side OSD image, the display-side superimposition instructing section 33 not only erases the display-side OSD image but also updates the display-side OSD information P and the display state information R.

In this way, when communication is cut off, OSD display state information on a counterpart device which information is managed in a device that is not carrying out OSD display is unconditionally updated to “non-display”. Then, when communication is re-established after this update to “non-display” at the cut-off of communication, both information on the device and the information on the counterpart device are updated. Accordingly, after such re-establishment of communication, no discrepancy occurs between the information on the device and the information on the counterpart device.

As described above, when cut-off of wireless connection is detected in the display device 30 and the transmission device 10 that are wirelessly connected to each other, each of the display device 30 and the transmission device 10 checks a type of OSD display that is being displayed on the display 37. Then, in a case where cancellation of display is required in a state checked as described above (e.g., a state where a menu that works with the display device 30 and the transmission device 10 is being displayed), the cancellation is carried out. Further, stored OSD information (transmitter-side OSD information P, display-side OSD information Q, and display state information R) is once cleared and after connection is restored, OSD information is newly updated. Because the stored OSD information is cleared in this way, the display device 30 can be used alone even after the cut-off of wireless connection. Further, it is also possible to manage a state of such a single device/apparatus with no influence on operation of the single device/apparatus.

[Decision Made by Superimposition Control Section 34]

Here, the following discusses decision made by the superimposition control section 34, with reference to FIGS. 12 to 16.

FIG. 12 illustrates one example of the definition table T1 for simultaneous/exclusive display by OSD type to which definition table the superimposition control section 34 makes reference. FIG. 13 illustrates one example of the definition table T2 for priority display by OSD type to which definition table the superimposition control section 34 makes reference.

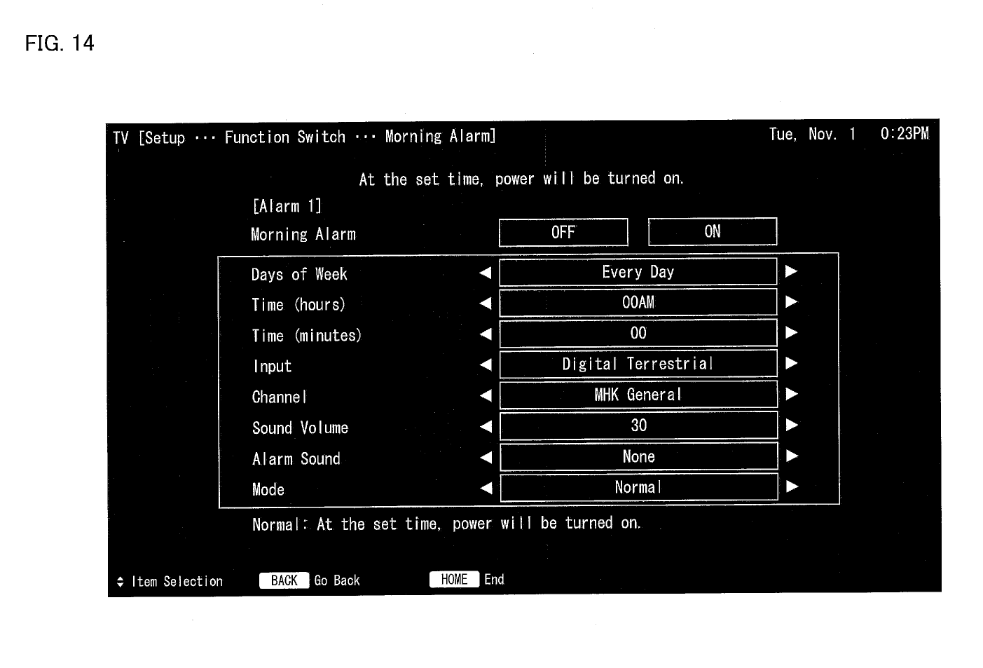

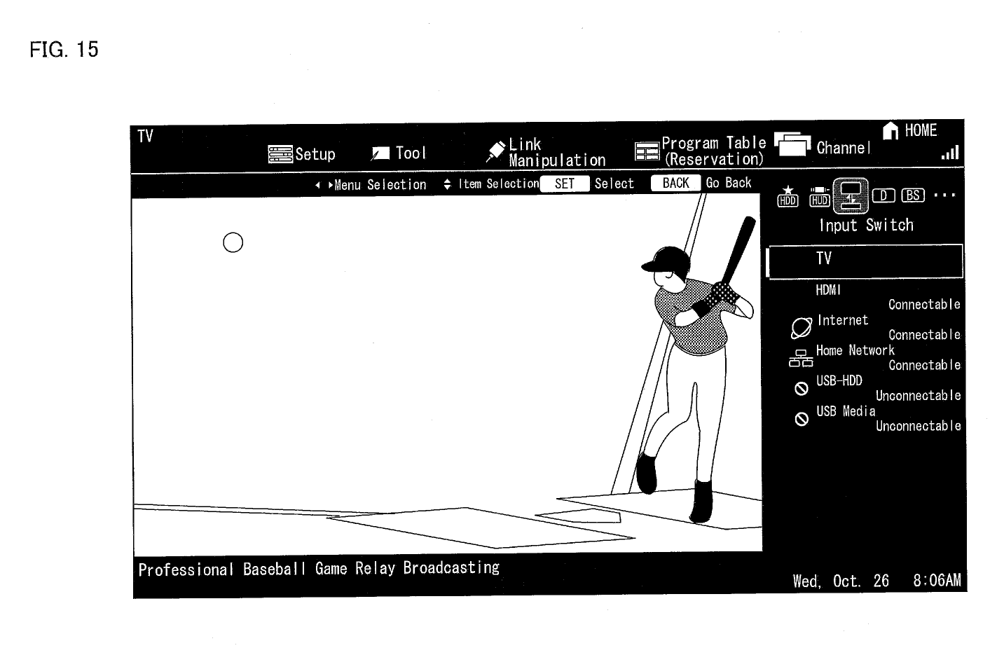

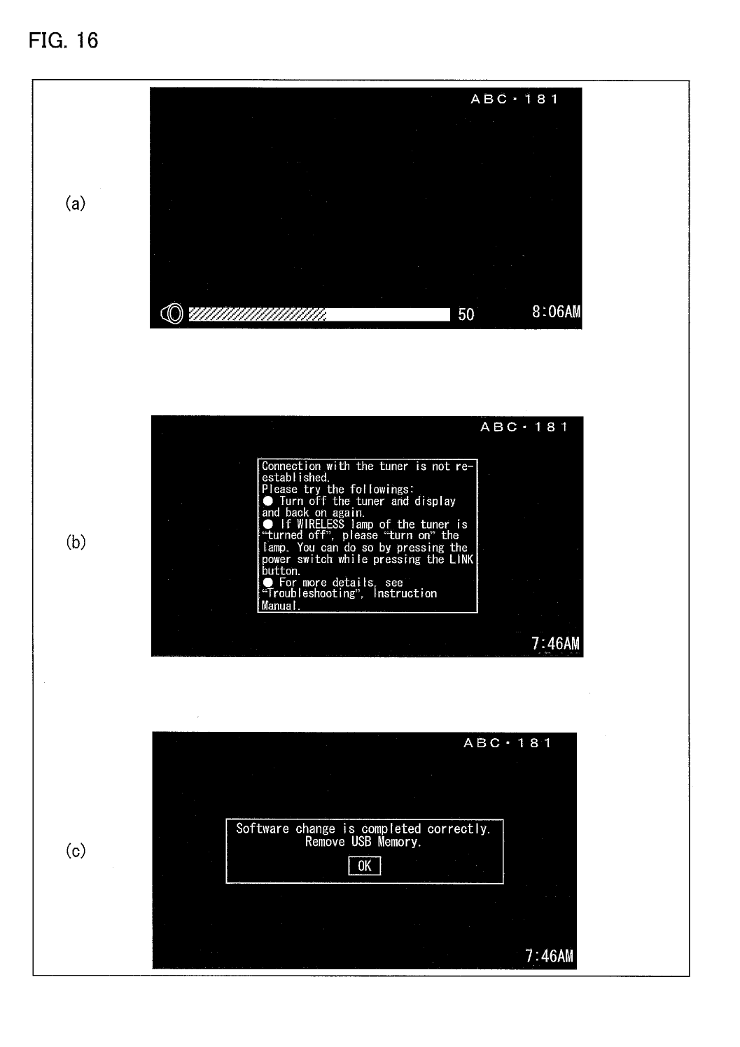

Further, FIG. 14 is an explanatory diagram illustrating an example display of a full-screen OSD and illustrates a state where a menu is displayed on a full screen. FIG. 15 is an explanatory diagram illustrating an example display of a video-image-containing OSD and illustrates a state where a letter L shaped menu is displayed which letter L shaped menu is made of a belt-like area on a top of a screen and a belt-like area on a right edge of the screen. FIG. 16 is an explanatory diagram of an example display of relatively small OSD images. (a) of FIG. 16 illustrates an example display of a relatively small normal OSD and shows a state where a channel call, a sound volume bar, and a clock are displayed. (b) of FIG. 16 illustrates an example display of a relatively small warning OSD and shows a state where a caution is displayed. (c) of FIG. 16 illustrates an example display of a relatively small OSD including a button and shows a state where a button to be focused is displayed.

The definition table T1 for simultaneous/exclusive display by OSD type defines whether to carry out simultaneous display or exclusive display depending on a combination of types of OSD images. More specifically, as illustrated in FIG. 12, in the definition table T1 for simultaneous/exclusive display by OSD type, whether to carry out simultaneous display of a transmitter-side OSD image and a display-side OSD image or exclusive display of either the transmitter-side OSD image or the display-side OSD image is defined for every combination of types of OSD images (“full-screen OSD”, “video-image-containing OSD”, “relatively small normal OSD”, “relatively small warning OSD”, and “relatively small OSD including a button”).

For example, in a case where the transmitter-side OSD image is a “video-image-containing OSD” and the display-side OSD image is a “relatively small warning OSD”, simultaneous display is to be carried out and both the “video-image-containing OSD” and the “relatively small warning OSD” are to be displayed. Meanwhile, in a case where the transmitter-side OSD image is a “full-screen OSD” and the display-side OSD image is a “relatively small OSD including a button”, exclusive display is to be carried out. Then, either one of the “full-screen OSD” and the “relatively small OSD including a button” is to be displayed. Whether to display the “full-screen OSD” or the “relatively small OSD including a button” is decided according to the definition table T2 (FIG. 13) for priority display by OSD type.

Next, the definition table T2 for priority display by OSD type defines whether to display the transmitter-side OSD image or the display-side OSD image in the case of exclusive display. More specifically, as illustrated in FIG. 13, the definition table T2 for priority display by OSD type defines whether to display the transmitter-side OSD image or the display-side OSD image, for every combination of a case where each of the transmitter-side OSD image and the display-side OSD image is a “relatively small OSD”, a “video-image-containing OSD”, a “full-screen menu OSD (normal)” or a “full-screen menu OSD (non-erasable).

In the above example, in a case where the transmitter-side OSD image is a “full-screen OSD” and the display-side OSD image is a “relatively small OSD (including a button)”, display priority is given to a later OSD. In other words, assume a case where a transmitter-side OSD superimposed video signal on which a “full-screen OSD” is superimposed is inputted into the display device 30 and the “full-screen OSD” that is the transmitter-side OSD image is being displayed on the display 37. On the above assumption, in a case where the display-side superimposition instructing section 33 outputs, to the superimposition control section 34, an instruction to superimpose a “relatively small OSD (including a button)”, a later OSD is given priority. Accordingly, the “relatively small OSD (including a button)” that is the display-side OSD image is superimposed and displayed on the display 37. On the other hand, assume a case where a “relatively small OSD (including a button)” that is the display-side OSD image is superimposed and being displayed on the display 37. In this case, when a transmitter-side OSD superimposed video signal on which a “full-screen OSD” that is the transmitter-side OSD image is superimposed is inputted into the display device 30, a later OSD is given priority. Accordingly, the “relatively small OSD (including a button)” that is the display-side OSD image is not superimposed. Then, only the “full-screen OSD” that is the transmitter-side OSD image is displayed on the display 37.

In this way, in the OSD display system 1 according to the present embodiment, it is possible to control simultaneous display or exclusive display, in accordance with a type of an OSD image that the display device 30 is required to display and a type of an OSD image of the transmission device 10. This makes it possible to appropriately display a menu that is an operation target. Accordingly, it is not necessary to decide an operation target at the time when an operation is to be made. This makes it possible to have a high operability.

Finally, the blocks of the transmission device 10 and the display device 30 in the OSD display system 1, in particular, the transmitter-side superimposing section 12, the transmitter-side superimposition control section 14, and the transmitter-side superimposed state information exchanging section 16 of the transmission device 10, and the display-side superimposition instructing section 33, the superimposition control section 34, the display-side superimposing section 35, and the display-side superimposed state information exchanging section 40 of the display device 30 may be realized by way of hardware or software as executed by a CPU as follows.

In the latter case where software is used, the transmission device 10 and the display device 30 each include a CPU (central processing unit) and memory devices (memory media). The CPU (central processing unit) executes instructions in programs for realizing the functions. The memory devices include a ROM (read only memory) which contains programs, a RAM (random access memory) to which the programs are loaded, and a memory containing the programs and various data. The objective of the present invention can also be achieved by mounting to each of the transmission device 10 and the display device 30 a computer-readable storage medium containing control program code (executable program, intermediate code program, or source program) for each of the transmission device 10 and the display device 30, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM (registered trademark)/EEPROM/flash ROM.

The transmission device 10 and the display device 30 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth (Registered Trademark), 802.11 wireless, HDR, mobile telephone network, satellite line, or terrestrial digital network. The present invention encompasses a computer data signal which is embedded in a carrier wave and in which computer data signal the program code is embodied electronically.

The present invention is not limited to the description of the embodiment above, but may be altered as appropriate by a skilled person within the scope of the claims. That is, the present invention encompasses an embodiment based on a proper combination of technical means modified as appropriate within the scope of the claims.

The present invention can also be expressed as follows. That is, a display device of the present invention receiving a video signal transmitted from a transmission device and displaying a video image represented by the video signal, the display device includes: display-side obtaining means obtaining transmitter-side OSD information indicative of a type of a transmitter-side OSD image superimposed by the transmission device on the video signal transmitted to the display device, the transmitter-side OSD information being notified by the transmission device; superimposition control means deciding whether or not to superimpose a display-side OSD image on the video signal to be displayed, in accordance with the type of the transmitter-side OSD image indicative of the transmitter-side OSD information obtained by the display-side obtaining means and a type of the display-side OSD image; and display-side superimposing means superimposing the display-side OSD image on the video signal received from the transmission device, in a case where the superimposition control means decides to superimpose the display-side OSD image.

Further, a method of the present invention for controlling a display device that receives a video signal transmitted from a transmission device and displays a video image represented by the video signal, the method includes the steps of: (a) obtaining transmitter-side OSD information indicative of a type of a transmitter-side OSD image superimposed by the transmission device on the video signal transmitted to the display device, the transmitter-side OSD information being notified by the transmission device; (b) deciding whether or not to superimpose a display-side OSD image on the video signal to be displayed, in accordance with the type of the transmitter-side OSD image indicative of the transmitter-side OSD information obtained in the step (a) and a type of the display-side OSD image; and (c) superimposing the display-side OSD image on the video signal received from the transmission device, in a case where superimposition of the display-side OSD image is decided in the step (b).

The above configuration makes it possible to control simultaneous display or exclusive display, in accordance with a type of an OSD image of the transmission device which OSD image is superimposed on a video signal and a type of an OSD image that the display device is required to display. In other words, it becomes possible to instantly decide a subsequent operation in performing a linked operation where the transmission device and the display device work with each other. Further, even when deterioration in a connection state results in cut-off of connection in a case where wireless connection is used or the like case, the above configuration makes it possible to prevent a discrepancy in linked operation state and/or in set value.

Therefore, a menu that is an operation target can be appropriately displayed. Accordingly, it is not necessary to decide an operation target at the time when an operation is to be made. This makes it possible to have a high operability.

Further, the display device of the present invention further includes: the display-side obtaining means includes a display-side OSD information storage section where the transmitter-side OSD information is stored, the transmitter-side OSD information being obtained by the display-side obtaining means from the video signal received from the transmission device, the transmitter-side OSD information being indicative of the type of the transmitter-side OSD image; and the display-side obtaining means (i) regularly obtaining the transmitter-side OSD information indicative of a type of the transmitter-side OSD image superimposed on a video signal most recently transmitted to the display device from the transmission device, and (ii) updating, by use of this transmitter-side OSD information, the transmitter-side OSD information stored in the display-side OSD information storage section.

The above configuration makes it possible to obtain transmitter-side OSD information indicative of a type of an OSD image of the transmission device regularly (for example, at predetermined intervals that does not apply too much load on the system).

Accordingly, the display device always grasps a type of a current OSD image of the transmission device. Therefore, the display device is not required to make an inquiry to the transmission device as to a display state of the transmitter-side OSD image at the time when the display device is to display a display-side OSD image (e.g., menu). Consequently, the display device can instantly decide a subsequent operation can be instantly decided.

Further, the display device of the present invention is configured to further include: superimposition requesting means requesting the superimposition control means to superimpose the display-side OSD image on the video signal; and display-side notification means notifying the transmission device of display-side OSD information indicative of the type of the display-side OSD image whose superimposition is requested by the superimposition requesting means.

The above configuration makes it possible to transmit, to the transmission device, display-side OSD information indicative of a type of an OSD image of the display device regularly (for example, at predetermined intervals that do not apply too much load on the system).

Accordingly, the transmission device always grasps a type of a current OSD image of the display device. Therefore, the transmission device is not required to make an inquiry to the display device as to a display state of the display-side OSD image at the time when the transmission device is to cause the display device to display a transmitter-side OSD image (e.g., menu). Consequently, the transmission device can instantly decide a subsequent operation.

Further, the display device of the present invention is configured such that when communication with the transmission device is cut off, the display-side obtaining means erases the transmitter-side OSD information stored in the display-side OSD information storage section.

In the above configuration, a state of connection with the transmission device that works with the display device is detected. Then, in a case where an OSD image, such as a menu, that works with the transmission device is opened at the time when the connection is cut off due to deterioration in connection state, display of the OSD image can be cancelled.

Accordingly, it is possible to prevent a discrepancy in linked operation state and/or in set value. This makes it possible to manage a state that occurs at the time when a linked operation is carried out by wireless communication but that never occurs at the time when a linked operation is carried out by wired communication.

A transmission device of the present invention transmitting a video signal to a display device, the transmission device includes: transmitter-side superimposing means superimposing a transmitter-side OSD image on the video signal that is to be transmitted to the display device; and transmitter-side notification means notifying the display device of transmitter-side OSD information indicative of a type of the transmitter-side OSD image superimposed by the transmitter-side superimposing means.

Further, a method of the present invention for controlling a transmission device transmitting a video signal to a display device, the method includes the steps of: (d) superimposing a transmitter-side OSD image on the video signal that is to be transmitted to the display device; and (e) notifying the display device of transmitter-side OSD information indicative of a type of the transmitter-side OSD image superimposed in the step (d).

In the above configuration, transmitter-side OSD information indicative of a type of a transmitter-side OSD image superimposed by the transmission device is transmitted to the display device. Accordingly, the display device can utilize the OSD information superimposed on a video signal. This allows the display device to control simultaneous display or exclusive display, in accordance with a type of the OSD image of the transmission device which OSD image is superimposed on the video signal and a type of an OSD image that the display device is required to display. In other words, when a linked operation is to be carried out, a subsequent operation can be instantly decided. Further, it becomes possible to prevent a discrepancy in state of the linked operation and/or in set value, even when connection is cut off due to deterioration in connection state in a case where wireless connection is used.

Therefore, a menu that is an operation target can be appropriately displayed. Accordingly, it is not necessary to decide an operation target at the time when an operation is to be made. This makes it possible to have a high operability.

Further, the transmission device of the present invention is configured to further include: transmitter-side obtaining means regularly obtaining display-side OSD information indicative of a type of a display-side OSD image whose superimposition on the video signal is requested in the display device; and transmitter-side OSD information storage section where the display-side OSD information is stored, the display-side OSD information having been obtained by the transmitter-side obtaining means from the display device.

The above configuration makes it possible to obtain display-side OSD information indicative of a type of an OSD image of the display device regularly (for example, at predetermined intervals that do not apply too much load on the system).

Accordingly, the transmission device always grasps a type of a current OSD image of the display device. Therefore, the transmission device is not required to make an inquiry to the display device as to a display state of the display-side OSD image at the time when the transmission device is to cause the display device to display a transmitter-side OSD image (e.g., menu). Consequently, the transmission device can instantly decide a subsequent operation.

Further, the transmission device of the present invention is configured such that the transmitter-side notification means regularly transmits, to the display device, the transmitter-side OSD information indicative of a type of the transmitter-side OSD image superimposed on a video signal most recently transmitted to the display device from the transmission device.

The above configuration makes it possible to transmit, to the display device, transmitter-side OSD information indicative of a type of an OSD image of the transmission device regularly (for example, at predetermined intervals that do not apply too much load on the system).

Accordingly, the display device always grasps a type of a current OSD image of the transmission device. Accordingly, the display device is not required to make an inquiry to the transmission device as to a display state of the transmission-side OSD image at the time when the display device is to display a display-side OSD image (e.g., menu. Therefore, the display device can instantly decide a subsequent operation.

Further, the transmission device of the present invention is configured such that when communication with the display device is cut off, the transmitter-side obtaining means erases the display-side OSD information stored in the transmitter-side OSD information storage section.

In the above configuration, a state of connection with the display device that works with the transmission device is detected. Then, in a case where an OSD image, such as a menu, that works with the display device is opened at the time when the connection is cut off due to deterioration in connection state, it is assumable that the display device cancels display of the OSD image. Accordingly, when communication is cut off, the transmission device can correspond to cancellation of display of the OSD image which cancellation is carried out by the display device, by erasing the display-side OSD information stored in the transmitter-side OSD information storage section.

Accordingly, it is possible to prevent a discrepancy in linked operation state and/or in set value. This makes it possible to manage a state that occurs at the time when a linked operation is carried out by wireless communication but that never occurs at the time when a linked operation is carried out by wired communication.

A display system of the present invention includes any one of the above display devices and any one of the transmission devices.

Note that the display device and the transmission device each may be realized by a computer. In such a case, the present invention encompasses a control program of the display device and the transmission device, which control program realizes the display device and the transmission device with use of a computer, by causing the computer to function as each of the above means, and a computer-readable storage medium containing the control program.

### INDUSTRIAL APPLICABILITY

The present invention is capable of appropriately display, on a display, OSDs such as respective menus of the display and a connected apparatus that is connected to the display and that is capable of working with the display. Accordingly, the present invention can be widely applied to a display system including a display and a connected apparatus which is connected to the display and supplies a video signal to the display.

### REFERENCE SIGNS LIST

1 OSD display system (display system)
10 transmission device
12 transmitter-side superimposing section (transmitter-side superimposing means)
15 transmitter-side superimposed state information storage section (transmitter-side OSD information storage section)
16 transmitter-side superimposed state information exchanging section (transmitter-side notification means, transmitter-side obtaining means)
30 display device
33 display-side superimposition instructing section (superimposition requesting means)
34 superimposition control section (superimposition control means)
35 display-side superimposing section (display-side superimposing means)
39 display-side superimposed state information storage section (display-side OSD information storage section)
40 display-side superimposed state information exchanging section (display-side obtaining means, display-side notification means)
P transmitter-side OSD information
Q display-side OSD information
S14, S19 transmitter-side notification step, step of notifying a display device
S15, S21 display-side obtaining step, step of obtaining transmitter-side OSD information
S34, S35 superimposition control step, step of deciding whether or not to superimpose
S37 display-side superimposition process, step of superimposing a display-side OSD image

1-14. (canceled)

15. A display system comprising:
a transmission device; and
a display device receiving and then displaying a video signal transmitted form the transmission device,
the transmission device including transmitter-side OSD information transmitting means that transmits, to the display device, transmitter-side OSD information indicative of a type of a transmitter-side OSD image, the transmitter-side OSD information transmitting means regularly transmitting the transmitter-side OSD information to the display device regardless of the presence of an inquiry from the display device;
the display device including transmitter-side-OSD-information receiving means that receives the transmitter-side OSD information.

16. A display device wirelessly connected to a transmission device, the display device receiving and then displaying a video signal transmitted from the transmission device, the display device comprising:
transmitter-side-OSD-information receiving means that receives transmitter-side OSD information indicative of a type of a transmitter-side OSD image of the transmission device, the transmitter-side OSD information having been transmitted regularly from the transmission device to the display device regardless of the presence of an inquiry from the display device.

17. A transmission device wirelessly connected to a display device, the transmission device transmitting a video signal to the display device, the transmission device comprising:
transmitter-side OSD information transmitting means that transmits, to the display device, transmitter-side OSD information indicative of a type of a transmitter-side OSD image.

18. The transmission device as set forth in claim 17, wherein:
the transmitter-side OSD information transmitting means regularly transmits the transmitter-side OSD information to the display device regardless of the presence of an inquiry from the display device.

19. A method of controlling a display device wirelessly connected to a transmission device, the display device receiving and then displaying a video signal transmitted from the transmission device, the method comprising the step of:
receiving transmitter-side OSD information that is regularly transmitted from the transmission device to the display device regardless of the presence of an inquiry from the display device.

20. A method of controlling a transmission device wirelessly connected to a display device, the transmission device transmitting a video signal to the display device, the method comprising the step of:
transmitting, to the display device, transmitter-side OSD information indicative of a type of a transmitter-side OSD image.
